(19) United States
(12) Patent Application Publication
(10) Pub. No.: US 2009/0321239 A1
(43) Pub. Date: Dec. 31, 2009

(54) SET OF CIRCUIT BREAKERS WITH INTERLOCK MEANS

(75) Inventor: Aijun Zhang, Guizhou (CN)

Correspondence Address: MCCARTER & ENGLISH, LLP BOSTON, 265 Franklin Street, Boston, MA, 02110, US

(73) Assignee: ZHEJIANG CHINT ELECTRICS CO., LTD., Wenzhou (CN)

(21) Appl. No.: 12/307,521

(22) PCT Filed: Jul. 3, 2007
(86) PCT No.: PCT/CN07/02062

§ 371 Date: Aug. 25, 2009

(30) Foreign Application Priority Data
Jul. 3, 2006 (CN) 200610090354.5

(51) Int. Cl. H01H 9/26

(52) U.S. Cl. 200/5 B

(57) ABSTRACT

A set of circuit breakers with interlock means, particularly a set of circuit breakers capable of realizing any mechanical interlock and unlock between two or more circuit breakers, wherein in the set of circuit breakers, each circuit breaker has an interlock means, said interlock means comprising a base plate 5, a driving lever 80, a control lever 8, two control arms 27, 28, three tension springs 10, 11, 12, and six hawsers 13, 14, 15, 16, 17, 18, two hawsers connected to two ends of the driving lever of each circuit breaker are respectively connected to a control arm of the other two circuit breakers.

### FIELD OF THE INVENTION

The present invention relates to a set of circuit breakers with interlock means, and in particular, relates to a set of circuit breakers for mechanically interlocking at least three circuit breakers.

### BACKGROUND OF THE INVENTION

In a power distribution system that supplies power with multiple loops, each loop is provided with a circuit breaker, and a circuit breaker which is typically switch-off and acts as an interconnection switch or a loop switch is provided between loops. If a loop therein disconnects due to power failure, the circuit breaker acting as an interconnection switch or a loop switch will close so as to ensure normal operation and power supply of the multi-loop power system mounted with the circuit breakers and of the load connected to the circuit breakers.

In practical application, a circuit breaker is required to perform some auxiliary functions aside from its normal operation functions so as to guarantee safety, for example, mechanical interlocking between two or more circuit breakers is required, aside from the electric interlocking between the set of circuit breakers having circuit breakers acting as interconnection switches or loop switches.

To implement interlocking between the set of circuit breakers, the mechanical interlocking methods and devices employed in the prior art are key interlock, leverage interlock and wire rope interlock, which are named by motion translation mediums. The mechanically interlocking circuit breaker means employed in current key interlock has a disadvantage that in-field manual operation is required to unlock the interlock, which can not satisfy the demand of automatic control.

In the prior art, some mechanically interlocking circuit breakers use the leverage interlock or wire rope interlock means or their combination with the key interlock means, disadvantage of which means lies in that only interlock between two circuit breakers can be implemented, and for interlock between three circuit breakers, random combination can not be implemented. Besides, under the current technical state, the known interlocking means for circuit breakers still have some drawbacks or performance deficiencies, though they can provide operating functions as required.

An invention patent No. 97125954.2 discloses a set of switches with interlock means, which discloses specifically the following technical features for this known mechanical interlock means: each switch has an elastically supported rocker, each rocker being operatively connected to means capable of locking a corresponding switch, each switch having a drive means connected to two ends of two cables. Since this known rocker that forms a mechanical interlocking means with cables is elastically supported, it is highly demanding on mounting and adjustment, with relatively poor repetitive positioning precision and vibration-proof performance. For a rocker directly connected to a trigger, its poor repetitive position precision and vibration-proof performance greatly affects the working reliability and robustness of the switches.

Specifically, since the force for locking a trigger in the prior art is directly the tensile force of a cable, movement of the rocker is realized by axial movement of the wire ropes inside the cable, thus it is highly demanding on the positioning precision of the cable member, which causes problems such as difficulty for adjustment, low productivity and high processing cost. Besides, in use, it is inevitable that connection of wire ropes becomes loose and deformed and that wire ropes become lengthened under tensile force. These problems directly impair positioning precision of the cable member, make locking operation out of order, and greatly affect the product's safety, reliability, robustness and service life.

### SUMMARY OF THE INVENTION

To overcome the above-mentioned drawbacks in the prior art, an objective of the present invention is to provide a set of circuit breakers having improved mechanical interlock means, the circuit breakers can not only satisfy the demand of automatic control, but also realize random combination of interlock/release between multiple circuit breakers, so as to meet different requirements on product interlock in practical operations.

Another important objective of the present invention is to provide a set of circuit breakers having interlock means, which has a good safety, robustness and reliability, is convenient for operating and adjusting, and is low in manufacturing cost but long in service life, so as to overcome the drawbacks in the constructional principle of the prior art circuit breaker mechanical interlocking mechanism means.

To achieve the above objectives, the present invention adopts the following solutions:

A set of circuit breakers with interlock means according to the present invention comprises at least three circuit breakers and at least six cables, wherein each circuit breaker in the set of circuit breakers has interlock means, the interlock means of each circuit breaker are interconnected by hawsers to translate drive force, each interlock means comprises a drive member, a control member, a locking member, a base plate, and a hawser mechanism; the base plate of the interlock means is provided with at least one control lever, at least one driving lever, at least two control arms and three elastic elements; the driving lever is operatively connected to a driving mechanism on the each circuit breaker; and the control lever is connected to a trigger of a circuit breaker locking means. Wire ropes of two hawsers that are connected to two ends of the driving lever of any of the circuit breakers are connected to a control arm of each of the other two circuit breakers. The control arm, under the joint action of the tensile force of the wire ropes and the elastic force of the elastic element, performs restricting or releasing the movement of the control lever. After movement of the control lever is released, under the elastic force of the elastic element, the control lever automatically completes locking a locking shaft of the each circuit breaker.

The drive member of the present invention has a driving lever whose two ends having a connection mechanism that bears hawsers, through which connection mechanism the driving lever connects two hawsers; in the middle of the driving lever is provided a shaft vertical to the driving lever, one end of the shaft being fixedly attached to the driving lever, middle of the shaft being movably attached to an access hole in the base plate, the other end of the shaft being attached to a driving means at the rear of the base plate and for operating the circuit breaker to open/close. The control member comprises two control arms, one end of each control arm having a hole movably attached to a shaft fixed on the base plate such that the control arms are rotatable around the shaft center, the other end of each control arm being fixed connected to wire ropes of the hawser, the wire ropes translating drive force of the driving lever to control arms of the other two circuit breakers. Each control arm is provided with a tension spring the other end of which is attached to the base plate. The direction of the tensile force of the tension spring is reversal to that of wire ropes. The control member has a control lever two ends of which are provided with two male tabs, middle of the control lever being fixedly attached to a shaft movably connected to the access hole in the base plate such that the control lever is rotatable around the shaft center, the other end of the shaft going through the base plate and adapted for being connected to the trigger of the circuit breaker at the rear of the base plate. On the control lever is provide a tension spring the other end of which is fixedly attached to the base plate. Under the joint action of the tensile force of the tension spring on the control lever and the tensile force of the wire ropes on the control arm, the mail tabs on the control lever may be maintained in contact or not in contact with a side edge of the control arm. The hawser comprises wire ropes and a sheath, the wire ropes being located in the middle of the sheath, and when two ends of the sheath are fixed, axial displacement between the wire ropes and the sheath is generated by pulling the wire ropes, thereby realizing the function of long-distance translation of axial movement. As to the hawser mechanism, one ends of the wire ropes are fixed on one end of the driving lever of a circuit breaker in the set of circuit breakers, the other ends of the wire ropes are fixed on one end of the control arm of another circuit breaker of the set of circuit breaker, with two ends of the sheath being respectively fixed on the base plates corresponding to two circuit breakers which fix the wire ropes.

For the set of circuit breakers with mechanical interlock means according to the present invention, when operating the drive means of one circuit breaker in the set of circuit breakers, the drive means drives the driving lever on the circuit breaker to rotate, rotation of which strains two wire ropes connected to two ends of the driving lever. By two strained wire ropes, side edges of the control arms of the other two circuit breakers of the set of circuit breakers are driven to separate from the male tabs of the control levers, thereby releasing the restriction to the control lever of the target circuit breaker, such that the control lever of the target circuit breaker, under the tensile force of the tension spring, realizes the required interlock of the set of circuit breakers. In reverse, when the wire ropes are released, due to the action of the tension spring on the control arm, the control arm may be reset and contact with the male tabs on the control lever, thereby realizing the required unlocking of the set of circuit breakers. According to the present invention, after the hawsers interconnects each circuit breaker of the set of circuit breakers in the predetermined connection way, through setting open/close of each circuit breaker, random combination of a plurality of circuit breaker states can be implemented, for example, when any two of the three circuit breakers switch on, the third circuit breaker can not switch on.

### BRIEF DESCRIPTION OF THE DRAWINGS

Hereinafter, the embodiments of the present invention are descried with reference to the accompanying drawings as below:

FIG. 1 is a side view of three interconnected circuit breakers with interlock means according to an embodiment of the present invention;

FIG. 2 is a structural diagram of the second circuit breaker shown in FIG. 1;

FIG. 3 is a structural diagram of control arms 27, 28 which are disposed on the second circuit breaker and not affected by transmission of drive means of other circuit breakers, as well as of a control lever 8 whose movement is restricted;

FIG. 4 is a three-dimensional diagram of the control lever 8 shown in FIG. 3;

FIGS. 5 and 6 diagrammatically illustrate two positions of a driving lever 80 of the first circuit breaker;

FIGS. 7 to 9 are diagrams of final positions of control arms 27, 28 after being driven by drive means of other different circuit breakers, and of control lever 8 of the second circuit breaker.

### DESCRIPTION OF THE PREFERRED EMBODIMENTS

Hereinafter, the preferred embodiments of the set of circuit breakers wither interlock means of the present invention are further described in detail by way of examples in the appended drawings.

The following example illustrates a set of circuit breakers comprising three circuit breakers according to the present invention, based on which the working principle and advantages of the interlock means of the present invention are illustrated. The set of circuit breakers according to the present invention is not limited to a set of circuit breakers comprising three circuit breakers.

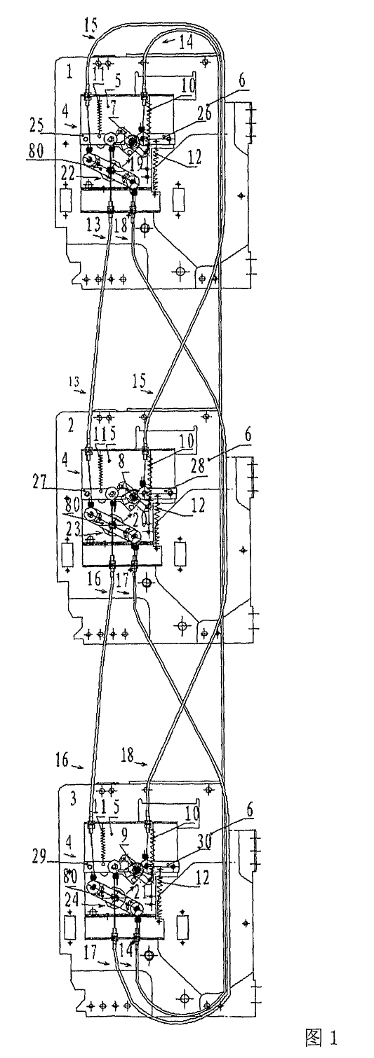

As shown in FIG. 1, a set of circuit breakers of the invention comprises circuit breakers 1, 2, 3. On the three circuit breakers, each circuit breaker has an interlock means 4. Each interlock means has a base plate 5, a driving lever 80 and three tension springs 10, 11 and 12. In the three interlock means, there further comprise control arms 25, 26, 27, 28, 29, 30, control levers 7, 8, 9 and hawsers 13, 14, 15, 16, 17, 18. Wire ropes at one end of the hawser 13 are fixedly attached to the left end of the driving lever 80 of the second circuit breaker 2, with the other end being fixedly attached to the left control arm 25 of the first circuit breaker 1. Wire ropes at one end of the hawser 14 are fixedly attached to the right end of the driving lever 80 of the third circuit breaker 3, with the other end being fixedly attached to the right control arm 26 of the first circuit breaker 1. Wire ropes at one end of the hawser 15 are fixedly attached to the left end of the driving lever 80 of the first circuit breaker 1, with the other end being fixedly attached to the right control arm 28 of the second circuit breaker 2. Wire ropes at one end of the hawser 16 are fixedly attached to the left end of the driving lever 80 of the third circuit breaker 3, with the other end being fixedly attached to the control arm 27 of the second circuit breaker 2. Wire ropes at one end of the hawser 17 are fixedly attached to the right end of the driving lever 80 of the second circuit breaker 2, with the other end being fixedly attached to the left control arm 29 of the third circuit breaker 3. Wire ropes at one end of the hawser 18 are fixedly attached to the right end of the driving 80 of the first circuit breaker 1, with the other end being fixedly attached to the right control arm 30 of the third circuit breaker 3. Two ends of the sheaths of hawsers 13, 14, 15, 16, 17, 18 are respectively fixedly attached to base plates 5 of corresponding interlock means. The structures and action principles of the interlock means 4 of each circuit breaker of the set of circuit breakers are identical. Hereinafter, for the sake of simplicity and to avoid repetition, only the interlock means 4 of the second circuit breaker 2 is taken as an example for description.

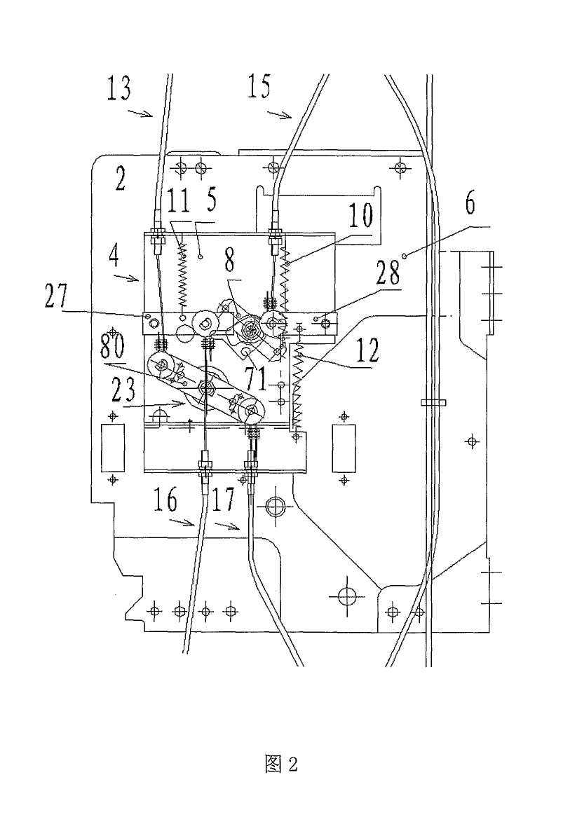

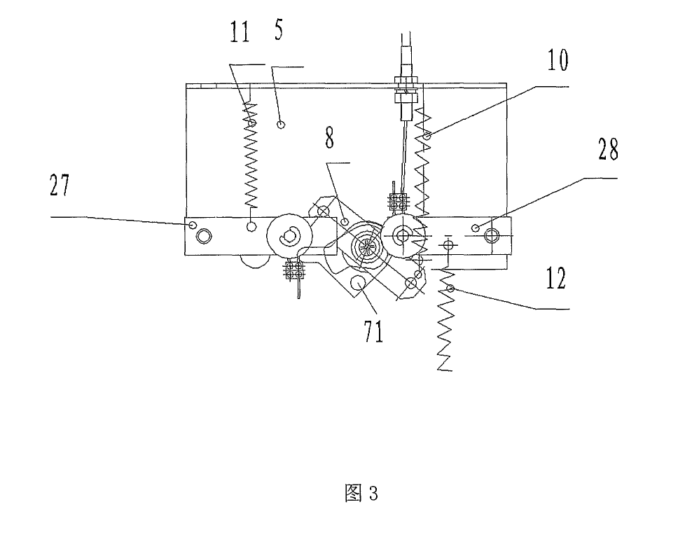

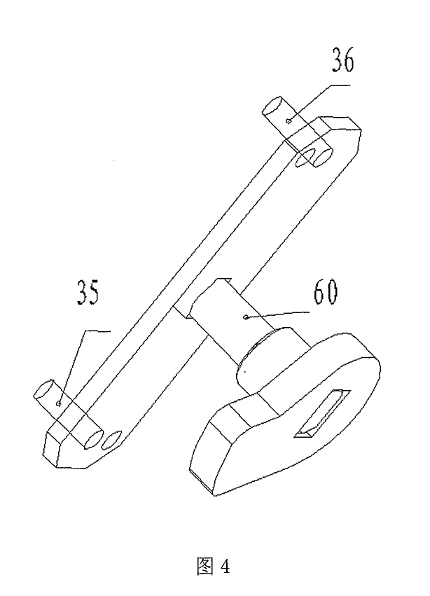

From FIGS. 2, 3 and 4, it can be seen that the interlock means 4 is fixed to a side plate 6 of the circuit breaker via a base plate 5. Parallel to the base plate 5 is provided a control lever 8 in the middle of which is provided a shaft 60 attached movably to a hole in the base plate 5. At two ends of the control lever 8 are provided two male tabs 35, 36, and at an appropriate position of the right end is attached a tension spring 10. When the restricting condition is completely eliminated, under the action of the tension spring 10, the control lever 8 is rotatable around the shaft center of the shaft 60. The shape of the control lever 8 is shown in FIG. 4. Driving levers, designated by reference sign 80 as a whole, are designated 22 in the first circuit breaker 1, 23 in the second circuit breaker 2, and 24 in the third circuit breaker 3. The driving lever 80 is disposed parallel on the base plate 5, the middle of the driving lever 80 is attached to a shaft that is movably attached to a hole in the base plate 5. The other end of the shaft is operationally attached to a plurality of triggers or indicator triggers of drive means of the circuit breaker, for example, attached to a main shaft fixed to the operating mechanism of the circuit breaker 2. The left end of the driving lever 80 is fixedly attached to wire ropes of the hawser 13, with the right end being fixedly attached to wire ropes of the hawser 17. Parallel to the base plate 5 are provided two control arms 27, 28. One ends of the control arms 27, 28 are provided with a hole movably attached to the shaft on the base plate 5. The other end of the control arm 27 is fixedly attached to wire ropes of the hawser 16 via a roller, an appropriate position in the middle of the control arm 27 being attached to the tension spring 11. The other ends of the control arm 28 is fixedly attached to wire ropes of the hawser 15, an appropriate position in the middle of the control arm 28 being attached to the tension spring 12. The other ends of the tension springs 11, 12 are respectively attached to the base plate 5. Each end of the sheaths of the hawsers 13, 15, 16, 17 is respectively fixed to the base plate 5 with a threaded terminal.

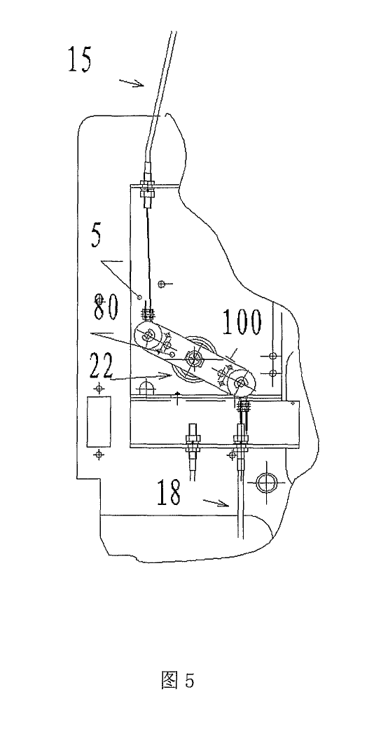

Hereinafter, the working principle of the interlocking mechanism of the present invention is described with reference to FIGS. 1, 5, 6, 7, 8, and 9.

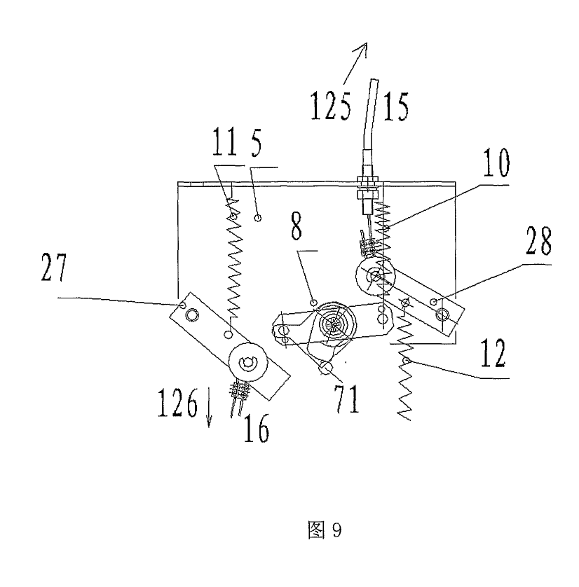

When all the three circuit breakers 1, 2 and 3 are in the opened positions, the control arm 27 is subject to tensile force of the tension spring 11 from the above and tensile force of the wire ropes 16 from the below. When it is located in the position such that the male tab 35 on the control lever 8 comes into contact with its side edge, the control lever 8 comes (see FIG. 9) or does not come (see FIG. 8) into contact with a locking means 71, thereby at least not affecting the reliable switch-on of the circuit breaker. The control arm 28 is subject to tensile force of the tension spring 10 from the below and tensile force of the wire ropes 15 from the above. When it is located in the position such that the male tab 36 on the control lever 8 comes into contact with its side edge, the control lever 8 comes or does not come into contact with the locking means 71, thereby at least not affecting the reliable switch-on of the circuit breaker.

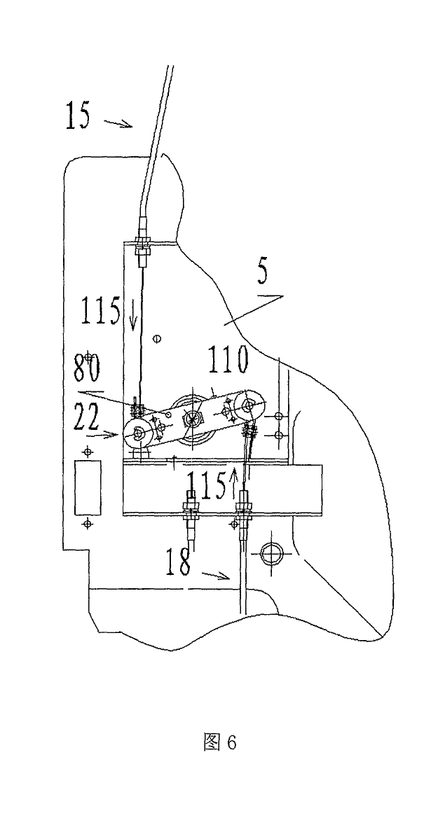

When, for example, only the first circuit breaker 1 switches on, the driving lever 22 of the first circuit breaker 1 is rotated to position 110, thereby straining wire ropes 15, 18 with tensile force 115 (see FIG. 6). Since the tensile force 115 strains the wire ropes 15, the control arm 28 of the second circuit breaker 2 is rotated clockwise (see FIG. 1 and FIG. 8), thereby eliminating its restriction on rotational movement of the control lever 8. Due to restriction of the control arm 27, the control lever 8 still maintains a certain distance from the locking shaft 71, thereby at least not affecting the reliable switch-on of the circuit breaker 2.

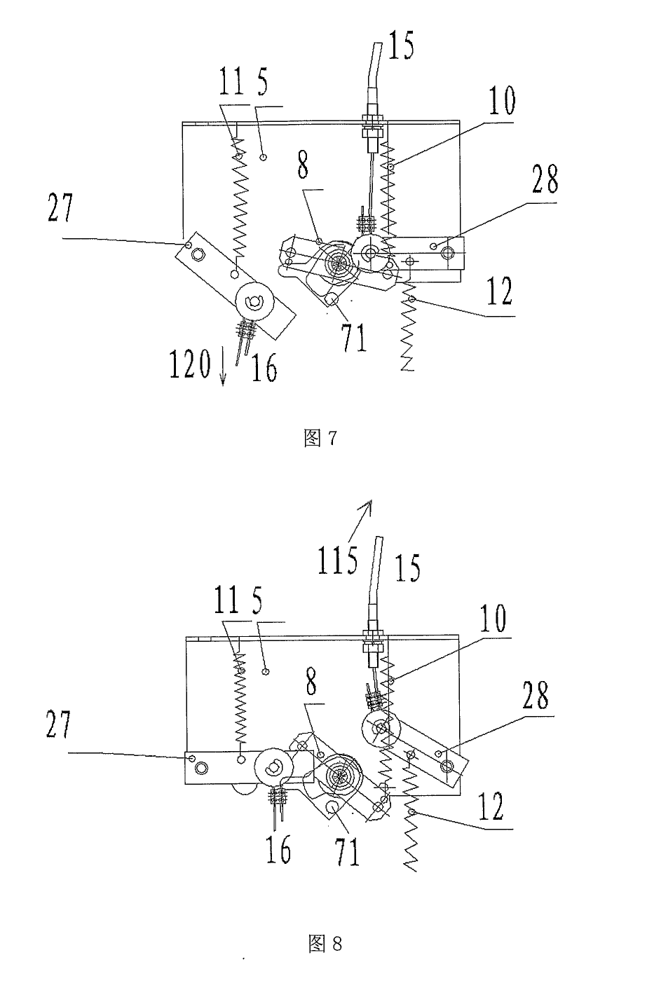

When only the third circuit breaker 3 switches on, the driving lever 24 of the third circuit breaker 3 strains the wire ropes 16 with the tensile force 120, thereby the control arm 27 of the second circuit breaker is rotated clockwise (see FIG. 1 and FIG. 7) and eliminating its restriction on rotational movement of the control lever 8. Due to restriction of the control arm 28, the control lever 8 still maintains a certain distance from the shaft 71 of the locking means, thereby at least not affecting the reliable switch-on of the circuit breaker 2.

When, for example, both the first circuit breaker 1 and the third circuit breaker 3 switch on, driving means of the circuit breakers 1, 3 rotate the driving levers 22, 24, thereby straining 15, 16, 18, 14 (see FIG. 9) with tensile forces 125, 126. Since the wire ropes 15, 16 move by being strained, the control arms 27 and 28 move clockwise, and their restriction on the rotational movement of the control lever 8 is eliminated. The control lever 8, under the action of the tension spring 10, rotates counterclockwise and comes into contact with the shaft 71 of the locking means, thereby preventing closure of the second circuit breaker 2.

With a completely identical manner, i.e. under the condition that both the second and third circuit breakers 2, 3 close, the first circuit breaker 1 may also be locked, and when both the first and the second circuit breakers 1, 2 are closed, the third circuit breaker 3 may also be locked.

From the embodiments and the accompanying drawings, the characteristics of the structure of the present invention are that: when the control lever 8 comes into contact with the locking shaft 71, the control lever 8 is in a contact condition state; the contact force between the control lever 8 and the locking shaft 71 is provided by the spring 10, which is different from the prior art in which the contact force is provided by tensile force of wire ropes; the control lever 8 adopts a shaft bearing support structure whose repetitive positioning and vibration-proof performances are better than the elastic support mechanism.

The structural characteristics of the present invention guarantee that the set of circuit breakers of the present invention has the following notable effects: good safety, robustness and reliability, ease of operating and adjusting, simple structure, low manufacturing cost, long service life and wide application, etc.

1. A set of circuit breakers with interlock means, comprising at least three circuit breakers (1, 2, 3) and at least six hawsers (13, 14, 15, 16, 17, 18), each circuit breaker in said set of circuit breakers has interlock means 4, interlock means of each circuit breaker being interconnected to translate drive force via hawsers, characterized in that
each interlock means comprises a drive member, a control member, a locking member, a base plate and a hawser mechanism;
a base plate 5 of said interlock means 4 is provided with at least one control lever 8, at least one driving lever 80, at least two control arms, and three elastic elements;
said control lever 8 is connected to a trigger of a circuit breaker locking means;
said driving lever 80 is operatively connected to a driving mechanism on the circuit breaker;
wire ropes of two hawsers connected to two ends of the driving lever 80 of any of said circuit breakers are respectively connected to one control arm of the other two circuit breakers;
said control arm, under joint action of tensile force of said wire ropes and elastic force of said elastic elements, performs restriction/restriction release of movement of said control lever 8;
said control lever 8, after movement restriction from the control arm is released, under the action of elastic force of said elastic element, automatically performs locking of a locking shaft 71 of the circuit breaker.

2. A set of circuit breakers according to claim 1, characterized in that: two ends of said driving lever 80 have a structure bearing wire ropes, on said driving lever 80 is provided a shaft accessing to the base plate 5, wherein the shaft mates with a corresponding hole on the base plate 5 such that the driving lever 80 is rotatable on a plane parallel to the base plate 5.

3. A set of circuit breakers according to claim 1, characterized in that: one ends of said control arms are provided a hole movably connected to a shaft fixed on the base plate 5, such that the control arms are configured to swing on a plane parallel to the base plate 5; each said control arm is respectively connected to the wire ropes and the elastic element so as to perform movement restriction or restriction release to the control lever 8 under joint action of tensile force of said wire ropes and elastic force of said elastic element.

4. A set of circuit breakers according to claim 1, characterized in that: in the middle of said control lever 8 is provided a shaft accessing to the base plate 5, the shaft mating with a corresponding hole on the base plate 5, such that the control lever 8 is rotatable on a plane parallel to the base plate 5; movement of the control lever 8 is restricted due to block at two ends thereof.

5. A set of circuit breakers according to claim 1, characterized in that: said hawser comprises wire ropes, a sheath, threaded terminals, and wiring means for wire ropes, the wire ropes being adapted to movably pass through the sheath, two ends of the sheath being provided with threaded terminals, and two ends of wire ropes being provided with the wiring means; the sheath is fixedly connected to the base plate 5 by virtue of the threaded terminals; wire ropes are fixedly attached to the driving lever and the control arm by virtue of the wiring means.

6. A set of circuit breakers according to claim 1, characterized in that: said elastic element is a tension spring, a leaf spring or a torsional spring, one end of which is connected to the control arm or the control lever, and the other end of which is connected to the base plate 5, and the direction of the elastic force of said elastic element acting on the control arm is opposite to that of the tensile force of the wire ropes; the direction of the elastic force of said elastic element acting on the control lever 8 is parallel to the base plate 5.

7. A set of circuit breakers according to any one of claims 1-5, characterized in that the driving lever 80, the control arms 25 and the hawsers should have the connection relationship as follows: wire ropes 15, 18 connected to two ends of the driving lever 22 of the first circuit breaker 1 are respectively connected to the control arm 28 of the second circuit breaker 2 and to the control arm 30 of the third circuit breaker 3; wire ropes 13, 17 connected to two ends of the driving lever 23 of the second circuit breaker 2 are respectively connected to the control arm 25 of the first circuit breaker 1 and to the control arm 29 of the third circuit breaker 3; and wire ropes 16, 14 connected to two ends of the driving lever 24 of the third circuit breaker 3 are respectively connected to the control arm 27 of the second circuit breaker 2 and the control arm 26 of the first circuit breaker 1.

8. A set of circuit breakers according to claim 3 or 4, characterized in that: said control lever 8 comes into direct contact with the control arms, i.e. no transitional element therebetween.

9. A set of circuit breakers according to claim 3 or 4, characterized in that: at least one transitional element for contacting is provided on the control lever 8 or the control arm, for example, a male tab, a stopper, or a pintle, etc.

10. A set of circuit breakers according to claim 3 or 4, characterized in that: there is no transitional element for connection between the elastic element and the control arm or the control lever.

11. A set of circuit breakers according to claim 3 or 4, characterized in that: there is at least one transitional element for connection between the elastic element and the control arm or the control lever, for example, a post, a clasp, or a tab, etc.

12. A set of circuit breakers according to any one of claims 2-5, characterized in that: bearing systems between said base plate 5 and driving lever 80, control arm, or control lever 8 are respectively hole-shaft bearing, or shaft-hole bearing, or slot-shaft bearing, or shaft-slot bearing; shaft center of said shaft is vertical to the plane of the base plate 5.

13. A set of circuit breakers according to claim 7, characterized in that: the connection between said wire ropes and the driving lever 80 or the control arm is direct, or through at least one transitional element, such as a pin roll, a shaft sleeve, a latch hook, or a roller.
